(19) United States
(12) Patent Application Publication
(10) Pub. No.: US 2019/0026760 A1
(43) Pub. Date: Jan. 24, 2019

(54) METHOD FOR PROFILING USER'S INTENTION AND APPARATUS THEREFOR

(71) Applicant: SK PLANET CO., LTD., Seongnam-si (KR)

(72) Inventors: Young-Sook HWANG, Seongnam-si (KR); Choon-Oh Lee, Suwon si (KR); Woo-Hyuk Jang, Hwaseong-si (KR); Yun-Seok Jang, Seoul (KR)

(73) Assignee: SK Planet Co., Ltd.

(21) Appl. No.: 16/038,402

(22) Filed: Jul. 18, 2018

(30) Foreign Application Priority Data
Jul. 21, 2017 (KR) 10-2017-0092567

(51) Int. Cl. G06Q 30/02; G06F 17/30

(52) U.S. Cl. CPC G06Q 30/0202; G06F 17/3089

(57) ABSTRACT

Disclosed herein are a method for user intention profiling and an apparatus for the same. Behavior data may be created based on logs collected in real time with regard to the online behavior of a user who accesses an online site, the purchase intention of the user and the item of interest may be detected based on the behavior data, keyword ranking information related to the user may be extracted in consideration of the similarity between a keyword vector corresponding to the item of interest and item models created based on multiple items registered in the online site, and a user intention profile for the user may be created based on at least one of the item of interest, the keyword ranking information, and a purchase probability included in the purchase intention.

### CROSS REFERENCE TO RELATED APPLICATION

This application claims the benefit of Korean Patent Application No. 10-2017-0092567, filed Jul. 21, 2017, which is hereby incorporated by reference in its entirety into this application.

### BACKGROUND OF THE INVENTION

### 1. Technical Field

The present invention relates generally to a method for user intention profiling for understanding the intention of a user, and more particularly to a method for analyzing the behavior of a user in real time while the user is using e-commerce and representing and providing the user's intention related to the behavior as data.

### 2. Description of the Related Art

With an exponential increase in the number of items and products provided through Internet services, users are required to spend a lot of time and effort in order to explore, search, and compare information. That is, considering the overabundance of information and the huge number of products, users must devote more time in order to make a good choice and a wise decision.

In order to solve this problem, required is a method for providing best shopping information to customers based on changing shopping patterns by analyzing the characteristics of customers' online behavior and profiling customers' buying patterns.

Also, providers for providing products and information thereon also need to understand the intention and purpose of customers in order to effectively provide products and information closer to the intention of customers at an appropriate time. Accordingly, it is necessary for service providers to construct a system that is capable of organizing and supplying suitable product groups at affordable prices at an appropriate time based on users' shopping patterns and trends at specific point in time.

In a conventional method, a customer's behavior related to a specific item or URL is analyzed and provided in the form of a profile. Through the analysis, a search word used to search for an item, an item that is clicked on, among listed items, and behavior on the page of the selected item (adding to a list, checking reviews, checking Q&A, adding to a cart, and the like) are rated, and then a highly rated item or category is profiled and provided as data. Also, data calculated based on a customer's history of past purchases may be combined and provided. Because this method is configured such that the customer's intention to search for an item is analyzed and provided at an item or category level or at the level of a search word for retrieving the item, the shopping pattern of a customer is limited to the category or item retrieved by the customer.

In another conventional method, text about an item is extracted from the web page where a user shops online, and user information is created using a keyword that is extracted by analyzing morphemes of the extracted text, whereby customer profiling is performed. Also, a method of normalizing keywords based on ontology has been proposed.

However, this method is not adequate to profile a user's search intention in real time due to the time-consuming operation required for analysis of morphemes and normalization through ontology mapping. Furthermore, there may be issues related to securing ontology suitable for user profiling, the range of application of ontology, determination of the suitability of application of ontology, and the like.

### Documents of Related Art

(Patent Document 1) Korean Patent No. 10-1679328, published on Nov. 18, 2016 and titled “Profiling system and method for collecting and utilizing profile of keyword”.

### SUMMARY OF THE INVENTION

An object of the present invention is to analyze, in real time, the intention of a user who uses e-commerce and to represent and provide the intention as data.

Another object of the present invention is to analyze behavior logs generated when a user uses e-commerce service and to profile a user's intention to search for an item using explicit keywords and figures so as to be used to improve the effectiveness of personalized recommendation, advertisement, searching, and marketing.

A further object of the present invention is to provide a method for effectively processing the user's search intention related to purchase in real time when there is a large number of users and a large number of items.

Yet another object of the present invention is to effectively structuralize and represent the feature information of the item or product that a user is searching for.

Still another object of the present invention is to automatically perform clustering of keywords having similar meaning, selection of representative keywords, and the like, thereby realizing cost efficiencies.

Still another object of the present invention is to effectively search for a similar product, a similar user, the relationship between a product and a user, a product or user that is associated with the feature represented by a certain keyword, and the like.

Still another object of the present invention is to improve real-time support for user profiling and use of the result thereof in a parallel distributed environment.

In order to accomplish the above objects, a method for user intention profiling according to the present invention may include creating behavior data corresponding to successive behavior based on logs that are collected in real time with regard to online behavior of a user who accesses an online site; detecting a purchase intention of the user and an item of interest based on the behavior data; extracting keyword ranking information related to the user in consideration of similarity between the keyword vector corresponding to the item of interest and item models created based on multiple items registered in the online site; and creating a user intention profile for the user based on at least one of the item of interest, the keyword ranking information, and a purchase probability included in the purchase intention.

Here, the item models may be learned based on item vectors created so as to correspond to the respective multiple items.

Here, the method may further include creating keyword sets for the respective multiple items by analyzing keywords based on morphemes; creating multiple keyword vectors for multiple keywords included in each of the keyword sets; and applying a weight for each keyword to the multiple keyword vectors and calculating a sum of scalar products of the multiple keyword vectors to which the weight for each keyword is applied, thereby creating the item vector.

Here, creating the multiple keyword vectors may be configured to extract multiple context keywords in consideration of a context of each of the multiple keywords, to represent a relationship of the multiple context keywords to the multiple keywords as vector values, and to perform learning such that a mean log probability reaches a maximum based on the vector values, thereby creating the multiple keyword vectors.

Here, creating the keyword sets may be configured such that, when there is a pair of keywords of which Pointwise Mutual Information (PMI) has a preset reference PMI value, among the multiple keywords, the keywords in the pair are combined as a single complex keyword so as to be regarded as a single keyword.

Here, the method may further include calculating the weight for each keyword in consideration of at least one of a frequency of the keyword in item information, a proportion of items in which the keyword appears, and a location at which the keyword appears.

Here, the behavior data may include at least one of a time at which behavior takes place, a user id, a terminal id, a Uniform Resource Identifier (URI), a search word, and information related to an item.

Here, the user intention profile may include information about a cluster of items that the user is interested in, which is created by applying a purchase probability of a behavior pattern, corresponding to the successive behavior, to the item vector corresponding to the item of interest as a weight.

Here, the method may further include calculating the purchase probability by comparing the behavior pattern with a purchase probability model created for the online site.

Also, a server according to the present invention includes memory for storing logs collected in real time with regard to online behavior of a user who accesses an online site and item models created based on multiple items registered in the online site; and a processor for detecting a purchase intention of the user and an item of interest using behavior data created so as to correspond to successive behavior based on the logs, extracting keyword ranking information related to the user in consideration of similarity between a keyword vector corresponding to the item of interest and the item models, and creating a user intention profile corresponding to the user based on at least one of the item of interest, the keyword ranking information, and a purchase probability included in the purchase intention.

Here, the item models may be learned based on item vectors created so as to correspond to the respective multiple items.

Here, the processor may create keyword sets for the respective multiple items by analyzing keywords based on morphemes, create multiple keyword vectors for multiple keywords included in each of the keyword sets, and apply a weight for each keyword to the multiple keyword vectors and calculate a sum of scalar products of the multiple keyword vectors to which the weight for each keyword is applied, thereby creating the item vector.

Here, the processor may extract multiple context keywords in consideration of a context of each of the multiple keywords, represent a relationship of the multiple context keywords to the multiple keywords as vector values, and perform learning such that a mean log probability reaches a maximum based on the vector values, thereby creating the multiple keyword vectors.

Here, when there is a pair of keywords of which Pointwise Mutual Information (PMI) has a preset reference PMI value, among the multiple keywords, the processor may combine the keywords in the pair as a single complex keyword so as to be regarded as a single keyword.

Here, the processor may calculate the weight for each keyword in consideration of at least one of a frequency of the keyword in item information, a proportion of items in which the keyword appears, and a location at which the keyword appears.

Here, the behavior data may include at least one of a time at which behavior takes place, a user id, a terminal id, a Uniform Resource Identifier (URI), a search word, and information related to an item.

Here, the user intention profile may include information about a cluster of items that the user is interested in, which is created by applying a purchase probability of a behavior pattern, corresponding to the successive behavior, to the item vector corresponding to the item of interest as a weight.

Here, the processor may calculate the purchase probability by comparing the behavior pattern with a purchase probability model created for the online site.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows a system for user intention profiling according to an embodiment of the present invention;

FIG. 2 is a flowchart that shows a method for user intention profiling according to an embodiment of the present invention;

FIG. 3 is a flowchart that shows an example of the process of a creating a keyword vector in the user intention profiling method according to the present invention;

FIG. 4 is a flowchart that shows an example of creating and learning an item model in the user intention profiling method according to the present invention;

FIG. 5 is a view that shows an example of the process of user intention profiling according to the present invention;

FIGS. 6 to 7 are views that show an example of creation of a keyword vector based on word-embedding according to the present invention;

FIGS. 8 to 9 are views that show an example of the process of creating a user intention profile according to the present invention; and

FIG. 10 is a block diagram that shows a server for performing user intention profiling according to an embodiment of the present invention.

### DESCRIPTION OF THE PREFERRED EMBODIMENTS

Technical terms used in this specification are used to describe only specific embodiments, and it is to be noted that the terms are not intended to limit the present invention. Furthermore, the technical terms used in this specification should be interpreted as having meanings that are commonly understood by a person having ordinary skill in the art to which the present invention pertains, unless specifically defined in this specification, and should not be interpreted as having excessively comprehensive meanings or excessively narrow meanings. Furthermore, if the technical terms used in this specification are erroneous technical terms that do not accurately represent the spirit of the present invention, they should be replaced with technical terms that may be correctly understood by a person having ordinary skill in the art. Furthermore, common terms used in the present invention should be interpreted in accordance with the definitions of dictionaries or in accordance with the context, and should not be interpreted as having excessively narrow meanings.

Furthermore, an expression of the singular number used in this specification includes an expression of the plural number unless clearly defined otherwise by the context. In this application, terms such as “comprise” and “include” should not be interpreted as essentially including all of several elements or several steps described in the specification, but should be broadly interpreted as potentially not including some of the elements or steps or as including additional element or steps.

Furthermore, terms including ordinal numbers, such as “first” and “second” in this specification, may be used to describe a variety of elements, but the elements should not be limited to the terms. The terms are used only to distinguish one element from another element. For example, a first element may be named a second element, and likewise a second element may be named a first element without departing from the scope of the present invention.

Hereinafter, preferred embodiments in accordance with the present invention are described in detail with reference to the accompanying drawings. The same or similar elements are assigned the same reference numerals irrespective of drawing numbers, and a redundant description thereof is omitted.

In the following description of the present invention, detailed descriptions of known functions and configurations which are deemed to make the gist of the present invention obscure will be omitted. The accompanying drawings of the present invention aim to facilitate understanding of the present invention and should not be construed as being limited to the accompanying drawings.

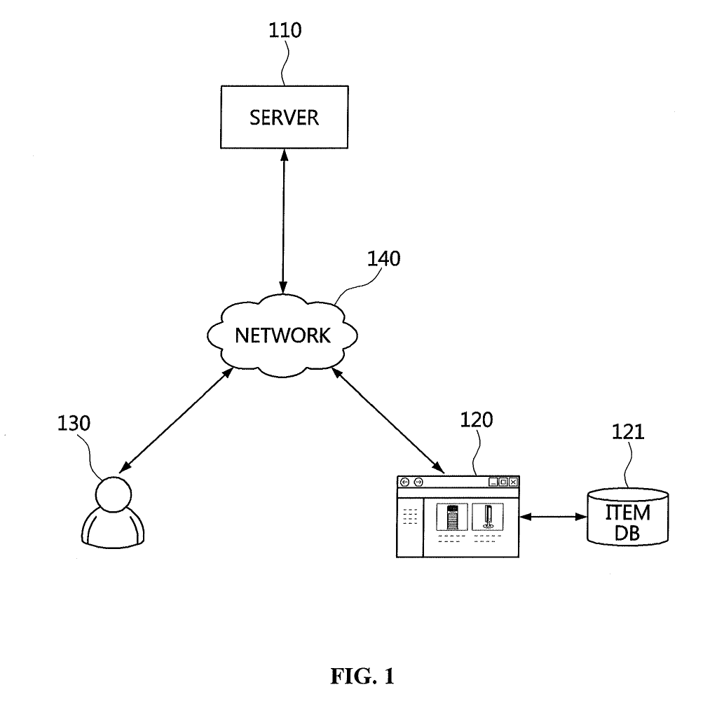

FIG. 1 is a view that shows a system for user intention profiling according to an embodiment of the present invention.

Referring to FIG. 1, the system for user intention profiling according to an embodiment of the present invention includes a server 110, an online site 120, an item database 121, a user 130, and a network 140.

The server 110 according to an embodiment of the present invention may be a device for performing user intention profiling based on the network 140 by considering the online behavior of the user 130 in real time when the user 130 is accessing the online site 120.

Here, the server 110 may analyze successive behavior of the user 130 as well as behavior pertaining to multiple items provided in the online site 120. That is, the server 110 may analyze the pattern of successive behavior from the visit of the user 130 to an e-commerce site, such as the online site 120, to the purchase of an item, and may create a user intention profile in consideration of the purchase intention or the item of interest, which is extracted from the analysis result.

Here, the online behavior of the user may be the continuous use of service by the user, for example, exploring individual pages provided by the online site 120, clicking on a button, and the like, and the feature of an item or category related to the online behavior may be extracted.

Also, the server 110 according to the present invention relates to real-time analysis and estimation of big data. The server 110 may combine a profiling result with the result of analysis of behavior logs based on the use of service related to retrieval of item information or purchase of an item in e-commerce service, and may thereby profile the user's intention to search for an item as explicit keywords and numbers. Therefore, the present invention may correspond to a data platform or data science that is used to enhance the effectiveness of personalized recommendation, advertisement, searching, and marketing.

Specifically, the server 110 may handle successive processes, such as acquiring real-time logs based on the online behavior of the user 130 from the online site 120, analyzing the logs, predicting the intention to search for an item, user intention profiling, and the like, in a seamless streaming method. Also, the server 110 may enable immediate transmission of a statistical analysis result from the user intention profile using an API.

Here, FIG. 1 illustrates the server 110 and the online site 120 as being separate from each other, but the server 110 and an operating server for running the online site 120 may be the same server, depending on the circumstances. That is, the server 110 for providing marketing management data may be included in the operating server of the online site 120 for providing e-commerce service. Alternatively, the operating server of the online site 120 for providing e-commerce service may be included in the server 110 for providing marketing management data.

The server 110 creates behavior data corresponding to successive behavior based on logs that are collected in real time with regard to the online behavior of the user 130 who accesses the online site 120.

Here, the behavior data may include at least one of the time at which behavior takes place, a user id, a terminal id, a Uniform Resource Identifier (URI), a search word, and information related to an item.

Also, the server 110 detects the purchase intention of the user 130 and the item of interest based on the behavior data.

Also, the server 110 extracts keyword ranking information related to the user in consideration of the similarity between a keyword vector corresponding to the item of interest and item models created based on multiple items registered in the online site 120.

Here, the item models may be learned based on item vectors that are created for corresponding ones of the multiple items.

Also, the server 110 creates keyword sets for the respective items registered in the online site 120 by analyzing keywords based on morphemes, and creates multiple keyword vectors for corresponding ones of multiple keywords included in each keyword set.

Here, multiple context keywords are extracted in consideration of the context of each of the multiple keywords, the relationship of the multiple context keywords to the multiple keywords is represented as vector values, and learning is performed such that a mean log probability reaches the maximum based on the vector values, whereby multiple keyword vectors may be created.

Here, when there is a pair of keywords of which the Pointwise Mutual Information (PMI) has a preset reference PMI value, among the multiple keywords, the keywords in the pair are combined into a complex keyword so as to be regarded as a single keyword.

Also, the server 110 applies a weight for each keyword to the multiple keyword vectors and calculates the sum of scalar products of the multiple keyword vectors, to which the weight for each keyword is applied, thereby creating an item vector.

Here, the server 110 may calculate the weight for each keyword in consideration of at least one of the frequency of the keyword in item information, the proportion of items in which the keyword appears, and the location at which the keyword appears.

Also, the server 110 creates a user intention profile for the user based on at least one of the item of interest, the keyword ranking information, and a purchase probability included in the purchase intention.

Here, the user intention profile may include information about a cluster of items that the user is interested in, which is created by applying the purchase probability of the behavior pattern, corresponding to the successive behavior, to the item vector of the item of interest as a weight.

Here, the server 110 may calculate the purchase probability by comparing the behavior pattern with a purchase probability model, which is created for the online site 120.

The online site 120 may be an Internet site that the user 130 accesses in order to use e-commerce service. Here, the operating server for running the online site 120 may be included in the server 110, or may be separate therefrom.

The item database 121 may be a storage module for storing and managing information about multiple items registered in the online site 120.

Here, the item database 121 may provide item information about the multiple items to the server 110 based on the network 140.

The user 130 may be a person who accesses the online site 120 and perform various actions during the use of e-commerce service. For example, the user 130 may access the online site 120 and exhibit various online behavior, such as searching for an item, viewing a detailed description of an item, adding an item to a cart, paying for an item, and the like.

Here, the user 130 may use e-commerce service by accessing the online site 120 using a user terminal, such as a mobile terminal, a computer, or the like.

For example, the user terminal is a device that is capable of running an application according to the present invention through connection with a communication network, and may be any of various types of terminals including all types of information communication devices, multimedia terminals, Internal Protocol (IP) terminals, and the like, without being limited to mobile communication terminals. Also, the user terminal may be a mobile terminal having various mobile communication specifications, such as a mobile phone, a Portable Multimedia Player (PMP), a Mobile Internet Device (MID), a smartphone, a tablet PC, a laptop, a netbook, a Personal Digital Assistant (PDA), an information communication device, and the like.

Also, the user terminal may receive various kinds of information, such as numbers, letters, and the like, and may deliver signals, which are input for setting various functions and controlling the functions of the user terminal, to the control unit via the input unit. Also, the input unit of the user terminal may be configured so as to include at least one of a keypad and a touch pad, which generate an input signal in response to the touch or manipulation by a user. Here, the input unit of the user terminal and the display unit thereof may form a single touch panel (or a touch screen), thereby performing both an input function and a display function. Also, the input unit of the user terminal may use all types of input means that may be developed in the future as well as currently existing input devices, such as a keyboard, a keypad, a mouse, a joystick, and the like.

Also, the display unit of the user terminal may display information about a series of operation states and operation results generated while the function of the user terminal is being performed. Also, the display unit of the user terminal may display the menu of the user terminal and user data input by a user. Here, the display unit of the user terminal may be configured as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the user terminal is configured in the form of a touch screen, the display unit of the user terminal may perform some or all of the functions of the input unit of the user terminal.

Also, the storage unit of the user terminal may include a main storage device and an auxiliary storage device as devices for storing data, and may store applications that are necessary for operation of the user terminal. The storage unit of the user terminal may include a program area and a data area. Here, when the user terminal activates each function in response to a request from a user, the user terminal provides the function by running corresponding applications under the control of the control unit. Particularly, the storage unit of the user terminal according to the present invention may store an Operating System (OS) for booting the user terminal, an application for sending and receiving information input for using e-commerce service, and the like. Also, the storage unit of the user terminal may store information about the user terminal and a content DB for storing multiple pieces of content. Here, the content DB may include execution data for executing content and attribute information about the content, and may store content usage information in response to execution of the content. Also, the information about the user terminal may include the specifications of the user terminal.

Also, the communication unit of the user terminal may function to send and receive data to and from the online site 120 over the network 140. Here, the communication unit of the user terminal may include an RF transmission medium for up-conversion and amplification of the frequency of a sending signal and an RF reception medium for low-noise amplification of a receiving signal and down-conversion of the frequency thereof. Such a communication unit of the user terminal may include a wireless communication module. Also, the wireless communication module is a component for sending or receiving data based on a wireless communication method, and may send and receive data to and from the online site 120 using any one of a wireless network communication module, a wireless LAN communication module, and a wireless PAN communication module when the user terminal uses wireless communication. That is, the user terminal may access the network 140 using a wireless communication module, and may send and receive data to and from the online site 120 over the network 140.

Also, the control unit of the user terminal may be a processing device for running an Operating System (OS) and respective components. For example, the control unit may control the overall process of accessing the online site 120. When access to the online site 120 is made through an application or the Internet, the control unit may control the overall process of running the application in response to the request by a user, and may perform control so as to send a request for using a service for e-commerce to the online site 120 at the time of execution of the application. Here, the control unit may perform control such that information about the user terminal required for user authentication is sent along with the request.

The network 140 may provide a channel via which the server 110, the online site 120, and the user 130 exchange data therebetween, and may be conceptually understood as including networks that are currently being used and networks that have yet to be developed. For example, the network may be any one of wired and wireless local networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future.

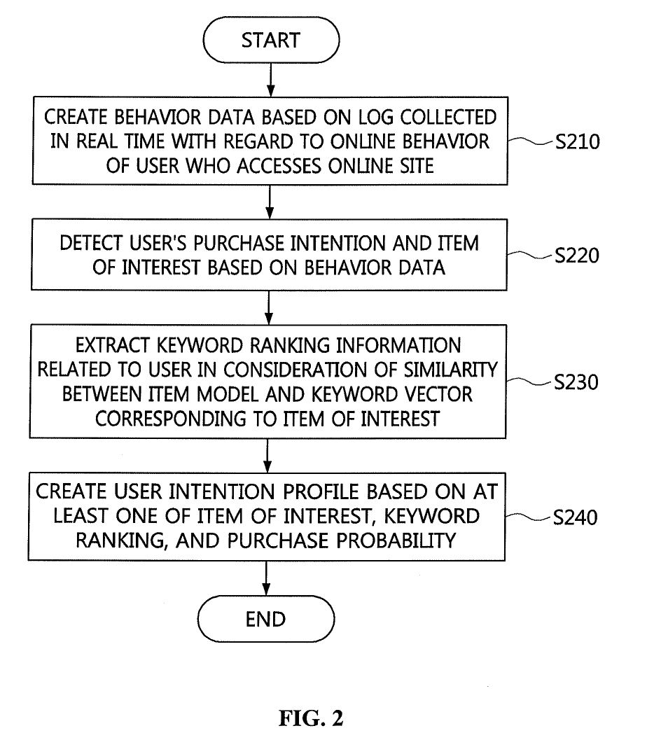

FIG. 2 is a flowchart that shows a method for user intention profiling according to an embodiment of the present invention.

Referring to FIG. 2, in the method for user intention profiling according to an embodiment of the present invention, based on logs collected in real time with regard to the online behavior of a user who accesses an online site, behavior data corresponding to successive behavior is created at step S210.

The present invention is for performing user intention profiling for a user who accesses an online site. To this end, the present invention may analyze the successive behavior of a user as well as behavior pertaining to a certain item or category. That is, successive online behavior from a user's initial visit to an online site to the purchase of an item may be analyzed.

Here, the purchase intention of the user and information about the item of interest observed in successive behavior to search for an item are profiled using a brand, a desired price level, a keyword representing the feature of an item, and the like. Here, unlike the conventional method in which only an item name or a detailed description of the item is used to detect an intention to search for the item of interest, meaningful keywords extracted through language processing and statistical analysis performed on an item name, a brand name, detailed information about a product, reviews, Q&A, a search keyword, and the like may be used to create a user intention profile for the user.

Here, a log may pertain to the online behavior of a user who is accessing the online site. For example, a log may represent explicit behavior, such as clicking on an item, checking a review, adding to a cart or deleting from a cart, making a payment, inputting a search word, clicking on an advertisement, social media activities, such as liking or sharing, or the like. Also, a log may include any implicit behavior from which the item of interest may be inferred, for example, behavior related to User Experience (UX), such as scrolling a mouse wheel, swiping out the screen, or the like, remaining for a long time on a certain page, revisiting the page of the same or a similar item or category, or the like. Here, the online behavior is not limited to these examples.

Here, a search word, a price, optional information, and the like, intended by the user, may be extracted based on URI information included in the log, and the extracted information is classified for each user, whereby behavioral data in a standardized format may be created.

Here, the log may be collected in real time immediately in response to the behavior of a user from the time at which the user accesses the online site. Also, the log may be collected in the form of a data stream, and may be preprocessed in order to be processed into a data format that is suitable for use in creating a user intention profile.

Here, the method for user intention profiling according to an embodiment of the present invention may use the real-time online behavior of a user, as described above. That is, unlike the conventional method, in which an item expected to be bought by a user or a purchase probability is determined using a record on past purchases of the user or profile information, the present invention may infer an item that is highly likely to be bought in the near future or a category including such an item based on a behavior pattern, such as the page that a user is visiting in the e-commerce site that the user is accessing. Because user intention profiling for the user who is accessing the online site is performed using this method, the user intention may be detected more accurately than when the conventional method is used.

Here, the channel used to collect a log is not limited to a specific channel. For example, a log corresponding to the online behavior of the user may be collected in real time through any of various channels, such as a mobile web, a mobile application, and a desktop web.

Also, the server according to an embodiment of the present invention may receive a log that is unified by aggregating all logs. Alternatively, the server may receive a log that is simplified by aggregating logs generated in some terminals. That is, the method of collecting logs is not limited to a specific method.

Here, the behavior data may include at least one of the time at which behavior takes place, a user id, a terminal id, a Uniform Resource Identifier (URI), a search word, and information related to an item. Here, the information related to an item may include an item number or a category number for identifying the corresponding item. Also, the information related to an item may include metadata based on which the importance of online behavior may be determined, such as the price of the item, an option related thereto, or the like.

Here, behavior data may be created for each session based on the time at which a user accesses the online site.

For example, the period from the time at which a user logs on to the online site to the time at which the user logs off therefrom is set as a single session, logs for online behavior observed during the single session are collected, and behavior data may be created therefrom.

In another example, the period from the time at which a user accesses an online site to the time at which the user leaves the online site is set as a single session, and behavior data for the session may be created.

Here, the start and termination of a single session may be set differently, and are not limited to a specific time.

Also, in the method for user intention profiling according to an embodiment of the present invention, the purchase intention of the user and the item of interest are detected based on the behavior data at step S220.

Here, the purchase intention may include a purchase probability related to the user.

Here, the purchase probability may increase when the successive online behavior of the user is determined to be meaningful.

Also, although not illustrated in FIG. 2, the purchase probability may also be calculated by comparing a behavior pattern with a purchase probability model, which is created for the online site.

Here, the purchase probability model may be a purchase probability model for the online site. That is, a behavior pattern is extracted from the behavior data collected from the corresponding online site, the frequency with which a purchase is made or a purchase is not made in the extracted behavior pattern is analyzed, and a purchase probability model may be created based on the analysis result.

For example, a purchase probability model may be created by extracting a purchase pattern and a non-purchase pattern based on the behavior pattern related to successive behavior that is frequently observed when multiple users who use the corresponding online site make a purchase and based on the behavior pattern related to successive behavior that is frequently observed when the multiple users do not make a purchase. Here, when the number of times a purchase is made or a purchase is not made is less than a certain number, the behavior pattern is not considered, whereby the operation for creating a purchase probability model may be processed faster.

Accordingly, the behavior pattern extracted from the behavior data created so as to correspond to the user is compared with the purchase pattern or non-purchase pattern included in the purchase probability model, whereby whether or not the user will buy an item may be calculated as a probability.

Also, in the method for user intention profiling according to an embodiment of the present invention, keyword ranking information related to the user is extracted at step S230 in consideration of the similarity between a keyword vector corresponding to the item of interest and item models created based on multiple items registered in the online site.

Here, the keyword vector corresponding to the item of interest may be acquired based on multiple keyword vectors that have been created for the multiple items in advance.

For example, the server according to an embodiment of the present invention may create multiple keyword vectors by acquiring item information about multiple items registered in the online site and then store the multiple keyword vectors in a separate database. When the user's item of interest is detected, an item corresponding thereto, among the multiple items, is retrieved, whereby the keyword vector of the corresponding item may be acquired.

The process of creating multiple keyword vectors will be briefly described below.

First, keyword sets for the respective multiple items may be created by analyzing keywords based on morphemes.

For example, morphemes may be analyzed by acquiring item information from the item database that stores item information about multiple items registered in the online site. Then, based on complex keyword processing and named entity recognition of the result of analysis of morphemes, keywords that represent the item well may be extracted.

Here, the keyword may be extracted based on various information corresponding to the unique brand name of the item, the model name thereof, the size thereof, the color thereof, the intended use thereof, the purpose thereof, and the like.

Here, if there is a pair of keywords of which the Pointwise Mutual Information (PMI) has a preset PMI value, among the multiple keywords, the keywords in the pair are combined into a complex keyword so as to be regarded as a single keyword.

For example, it may be assumed that keyword B, which is the brand name of item A, is extracted from the result of analysis of morphemes in item information about the item A. Then, when keyword C, which is statistically meaningful with regard to the keyword B, is extracted using word co-occurrence, a complex keyword that combines the keyword B with the keyword C may be regarded as a single keyword about item A.

Here, complex keywords, each of which is configured with two or more words, may be extracted and included in each keyword set by repeatedly performing complex keyword processing for the result of analysis of morphemes in item information of all of the multiple items.

Then, multiple keyword vectors may be created for the respective multiple keywords included in each of the keyword sets.

Here, the keyword vector may be a semantic vector of a certain size, represented by applying a context-based word-embedding model to a specific keyword. That is, the semantic vector is a vector of a specific size that is learned from multiple keywords used for representing the characteristics of an item and the context of the keywords, and may be a numeric expression of the characteristic of the item represented with the keyword in a vector space.

Here, multiple context keywords are extracted in consideration of the context of each of the multiple keywords, and the relationship of the multiple context keywords to the multiple keywords may be represented as vector values.

For example, it may be assumed that “OH radical”, “air purifier”, “fine dust”, “sterilization”, and the like are extracted as the context keywords of item A, the keyword of which is “air purifier”. Similarly, it may be assumed that “anion”, “air purifier”, “triple filter”, “low power”, “fine dust”, and the like are extracted as the context keywords of item B, the keyword of which is “air purifier”. Here, the keyword “air purifier” may be represented as a specific vector value, from which the meaning of an air purifier is drawn, by numerically learning the context keywords extracted from the item A and the item B in a vector space.

Here, learning is performed such that the mean log probability reaches the maximum based on the vector values, whereby multiple keyword vectors may be created.

For example, a keyword vector for keyword K may be the result of learning that is performed such that the mean log probability of the keyword K for all of the context keywords thereof is maximized, and may be calculated using the following Equation (1):

$$\frac{1}{T} {\sum }_{t = k}^{T - k} log Pr ( {K}_{t} \vert {K}_{t - k} , … , {K}_{t + k} ) \qquad ( 1 )$$

Here, item models may be learned based on item vectors that are created so as to correspond to the multiple items.

Here, the item vector may be the unique feature vector of an item that is represented using the keyword set corresponding to the item and the keyword vectors created based on the multiple keywords included in the keyword set.

Here, a weight for each keyword is applied to the multiple keyword vectors, and the sum of scalar products of the multiple keyword vectors, to which the weight for each keyword is applied, is calculated, whereby an item vector may be created.

For example, the item vector Pᵢ may be calculated as the sum of scalar products of the weight λᵢⱼ for the item, assigned to each of the m keywords extracted from item information, and the keyword vector Kᵢⱼ, as shown in Equation (2).

$${P}_{i} = {\sum }_{i = 1}^{m} {λ}_{ij} {K}_{ij} \qquad ( 2 )$$

Here, the dimension of the item vector may be the same as that of the keyword vector.

Here, the weight for each keyword may be calculated in consideration of at least one of the frequency of the keyword in item information, the proportion of items in which the keyword appears, and the location at which the keyword appears.

For example, when the frequency of the keyword in item information is tf, when the proportion of items in which the keyword appears is idf, when the weight depending on the location at which the keyword appears is α, and when the number of multiple items registered in the item database is |P|, the weight λᵢⱼ for each keyword may be calculated as shown in Equation (3).

$${λ}_{ij} = \frac{α \times {tf}_{ij}}{{\sum }_{k = 1}^{k = m} {tf}_{ik}} \times {idf}_{ij} , {idf}_{ij} = \frac{\vert P \vert}{count ( {P}_{j} )} \qquad ( 3 )$$

where Pⱼ denotes the number of items that include the j-th keyword, among multiple items.

Here, depending on the quality of the item vector, the weight model of Equation (3) may be adjusted.

Here, the item model may be learned for the item vectors of the multiple items registered in the item database at regular intervals.

Here, the size of the item vector may be the same as the size of the keyword vector. When user intention profiling is performed in real time, the size of the keyword vector and the item vector may be set in consideration of available memory and the efficiency of parallel distributed processing.

Also, in the method for user intention profiling according to an embodiment of the present invention, a user intention profile for the user is created at step S240 based on at least one of the item of interest, keyword ranking information, and the purchase probability included in the purchase intention.

Here, the user intention profile may include information about a cluster of items that the user is interested in, which is created by applying the purchase probability of the behavior pattern, corresponding to successive behavior, to the item vector of the item of interest as a weight.

That is, the user intention profile may include a profile of the user's item of interest and a profile of the user's keyword of interest.

Here, a profile of a price range desired by the user and the preferred brand may also be calculated by applying the purchase probability of the behavior pattern as a weight.

For example, a price range may be readjusted through linear interpolation between the current desired price range, which is detected based on the behavior data, and the price range value that is initialized based on at least one of the minimum price, the average price, and the maximum price.

In another example, the purchase probability of the behavior pattern, from which each of the items in which the user is interested is detected, is applied to the price information of the corresponding item as a weight, whereby the price range may be estimated.

Also, in the case of the preferred brand, the purchase probability of the behavior pattern, from which the item of interest is detected, is applied to the brand of the corresponding item as a weight, whereby the degree of interest in the brand may be calculated.

That is, in the method for user intention profiling according to an embodiment of the present invention, the similarity between the item model and the vector value, acquired by applying the purchase probability to the item vector for the item of interest as a weight, is calculated, and a keyword having a high similarity is included in the user intention profile depending on the ranking thereof, whereby information about keywords in which the user is interested may be provided.

Alternatively, in the method for user intention profiling according to an embodiment of the present invention, N keywords are extracted for each of the multiple items registered in the online site, and the probability of buying an item is applied to the extracted keywords of the corresponding item as a weight, whereby keyword ranking information for each item may be created. Then, the degree of interest in each of the keywords is calculated by multiplying the probability of buying the item of interest, which is extracted based on the behavior data of the user, by the similarity of the keywords of the item of interest, and the calculated degree of interest is sorted, whereby keyword ranking information may be created.

Here, the degree of interest in the item, that is, the purchase intention of the user, may decrease over time. Also, when the item of interest has been bought, interest in the corresponding item may be determined to be lost.

Accordingly, while user intention profiling is being performed in real time, the item for which a search activity related to purchase is not conducted during a certain session is subject to application of an exponential decay function with a time constant, whereby the purchase probability, which is a weight to be applied to the item vector, may be gradually decreased.

Also, when a specific item has been bought, user intention profiling may be performed after setting the purchase probability that is finally applied to the item to zero.

As described above, user intention profiling serves to structuralize and represent information about the features of the item that a user is searching for in the online site, and the key feature information may be shown in the category of the item, the brand thereof, the price thereof, the model name thereof, keywords related to the main attributes and functions of the item, and keywords that represent additional information about the item. Here, the category, the brand, and the price may use a predefined keyword or code, and the main attributes or functions of the item may be represented in different types even if they have the same meaning.

Also, the present invention represents the item characteristic preferred by the user, which is observed in the item search intention, as a keyword. Here, rather than using the word used to describe the item information, that is, rather than using the keyword itself, consecutive words that are used together may be extracted as a single complex keyword based on statistical word co-occurrence. Also, various context keywords that appear around the extracted keyword are encoded into a vector space of a fixed dimension, and user intention profiling may be performed using the result of encoding.

Also, a keyword vector created according to an embodiment of the present invention may efficiently represent the item search intention of the user because it comprehensively reflects the semantic characteristics of the keyword related to the item and because it is good at combining keywords that have similar meaning but are represented in different types.

Particularly, in the conventional method for normalizing keywords using ontology, there may be issues such as overhead arising from the construction of ontology, the degree of expressiveness depending on the scale of ontology, and the like. However, when keyword embedding according to the present invention is used, because clustering of keywords having similar meaning, selection of representative keywords, and the like may be automatically performed, cost efficiencies may be expected. Also, because measurement of the degree of similarity and keyword ranking are performed through vector operations, a parallel and distributed processing environment may be effectively used when real-time service is provided for a large number of items and users.

Also, because an item model and the item search intention of a user are represented using a keyword-embedding vector as a medium therebetween, extracting a keyword for representing the feature of an item, ranking keywords in which the user is interested, and the like may be performed using a vector operation, and a similar item, a similar user, the relationship between an item and a user, an item or user that is associated with the feature represented by a certain keyword, and the like may be effectively retrieved using the vector similarity operation.

Also, although not illustrated in FIG. 2, in the method for user intention profiling according to an embodiment of the present invention, information that is necessary for user intention profiling may be sent and received through a communication network. Particularly, data about the online behavior of a user or item information about multiple items registered in an online site may be received from a special operating server for running the online site.

Also, although not illustrated in FIG. 2, in the method for user intention profiling according to an embodiment of the present invention, various kinds of information generated during the above-described user intention profiling process may be stored in a separate storage module.

Through the above-described user intention profiling method, the intention of the user who uses e-commerce may be analyzed in real time and the analysis result may be provided as data.

Also, analysis of a behavior log generated when a user uses e-commerce service and item search intention of the user may be profiled using explicit keywords and figures so as to be used to enhance the effectiveness of personalized recommendation, advertisement, searching, and marketing.

Also, there may be provided a method for effectively processing the user's search intention related to purchase in real time when there is a large number of users and a large number of items.

Also, information about the features of the item or product that a user is searching for may be effectively structuralized and represented.

Also, clustering of keywords having similar meaning, selection of representative keywords, and the like are automatically performed, whereby cost efficiencies may be realized.

Also, a similar product, a similar user, the relationship between a product and a user, a product or user that is associated with the feature represented by a certain keyword, and the like may be effectively retrieved.

Also, real-time support for user profiling and the use of the result thereof in a parallel distributed environment may be improved.

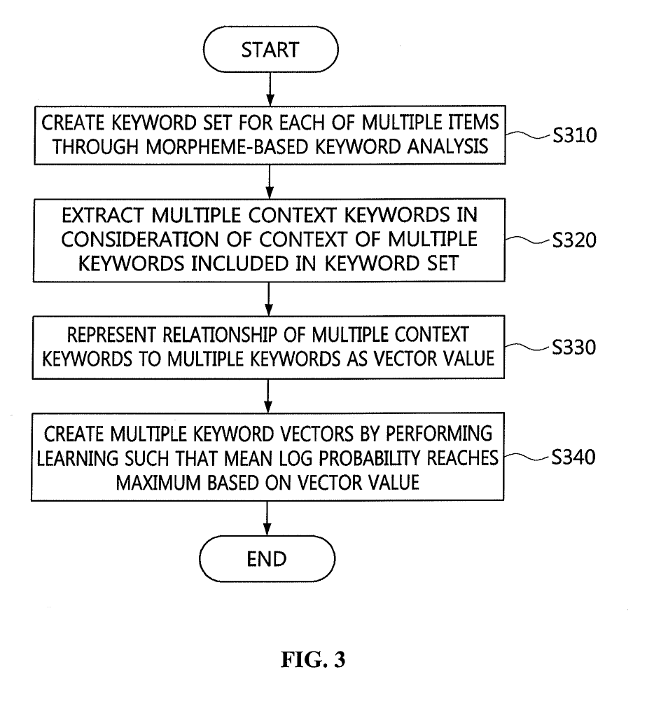

FIG. 3 is a flowchart that shows an example of the process of creating a keyword vector in the user intention profiling method according to the present invention.

Referring to FIG. 3, in the process of creating a keyword vector in the user intention profiling method according to the present invention, first, keyword sets for respective multiple items may be created by analyzing keywords based on morphemes at step S310.

For example, morphemes may be analyzed by acquiring item information from an item database that stores item information about multiple items registered in an online site. Then, based on complex keyword processing and named entity recognition of the result of analysis of morphemes, keywords that represent the item well may be extracted.

Here, the keywords may be extracted based on various information corresponding to the unique brand name of an item, the model name thereof, the size thereof, the color thereof, the intended use thereof, the purpose thereof, and the like.

Here, if there is a pair of keywords of which the Pointwise Mutual Information (PMI) has a preset PMI value, among the multiple keywords, the keywords in the pair are combined into a complex keyword so as to be regarded as a single keyword.

For example, it may be assumed that keyword B, which is the brand name of item A, is extracted from the result of analysis of morphemes in item information about the item A. Then, when keyword C that is statistically meaningful with regard to the keyword B is extracted using word co-occurrence, a complex keyword that combines the keyword B with the keyword C may be regarded as a single keyword about the item A.

Then, multiple context keywords may be extracted at step S320 in consideration of the context of each of the multiple keywords included in the keyword set, and the relationship of the multiple context keywords to the multiple keywords may be represented as vector values at step S330.

For example, it may be assumed that “OH radical”, “air purifier”, “fine dust”, “sterilization”, and the like are extracted as the context keywords of item A, the keyword of which is “air purifier”. Similarly, it may be assumed that “anion”, “air purifier”, “triple filter”, “low power”, “fine dust”, and the like are extracted as the context keywords of item B, the keyword of which is “air purifier”. Here, the keyword “air purifier” may be represented as a specific vector value, from which the meaning of an air purifier is drawn, by numerically learning the context keywords extracted from the item A and the item B in a vector space.

Then, learning is performed such that the mean log probability reaches the maximum based on the vector values, whereby multiple keyword vectors may be created at step S340.

For example, a keyword vector for keyword K may be the result of learning that is performed such that the mean log probability of the keyword K for all of the context keywords thereof is maximized, and may be calculated using the following Equation (1):

$$\frac{1}{T} {\sum }_{t = k}^{T - k} log Pr ( {K}_{t} \vert {K}_{t - k} , … , {K}_{t + k} ) \qquad ( 1 )$$

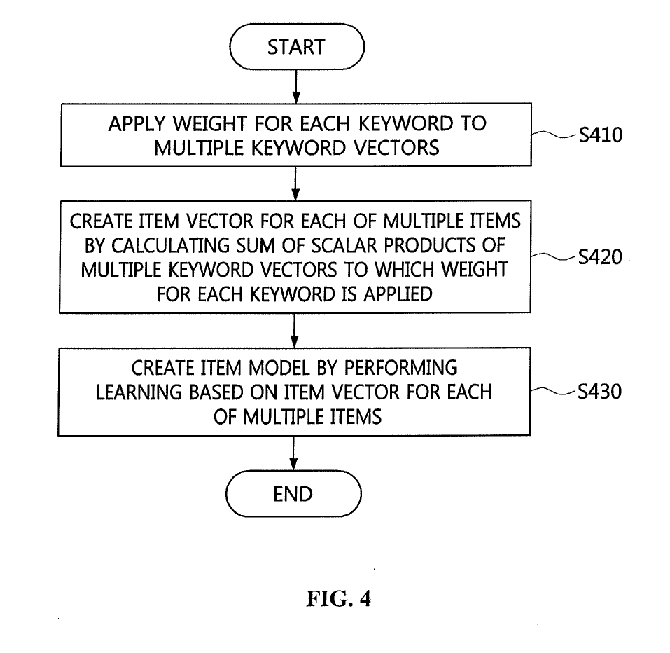

FIG. 4 is a flowchart that shows an example of the process of creating and learning an item model in the user intention profiling method according to the present invention.

Referring to FIG. 4, in the process of creating and learning an item model in the user intention profiling method according to the present invention, first, a weight for each keyword may be applied to each of the multiple keyword vectors at step S410.

For example, the item vector Pᵢ may be calculated as the sum of scalar products of the weight λᵢⱼ for the item, assigned to each of m keywords extracted from item information, and the keyword vector Kᵢⱼ, as shown in Equation (2).

$${P}_{i} = {\sum }_{i = 1}^{m} {λ}_{ij} {K}_{ij} \qquad ( 2 )$$

Here, the dimension of the item vector may be the same as that of the keyword vector.

Then, the sum of scalar products of the multiple keyword vectors to which the weight for each keyword is applied is calculated, whereby item vectors for the respective multiple items may be created at step S420.

Here, the weight for each keyword may be calculated in consideration of at least one of the frequency of the keyword in item information, the proportion of items in which the keyword appears, and the location at which the keyword appears.

For example, when the frequency of the keyword in item information is tf, when the proportion of items in which the keyword appears is idf, when the weight depending on the location at which the keyword appears is α, and when the number of multiple items registered in the item database is |P|, the weight λᵢⱼ for each keyword may be calculated as shown in Equation (3).

$${λ}_{ij} = \frac{α \times {tf}_{ij}}{{\sum }_{k = 1}^{k = m} {tf}_{ik}} \times {idf}_{ij} , {idf}_{ij} = \frac{\vert P \vert}{count ( {P}_{j} )} \qquad ( 3 )$$

where Pⱼ denotes the number of items that include the j-th keyword, among multiple items.

Then, item models may be created at step S430 by performing learning based on the item vectors for the respective multiple items.

Here, the item models may be learned for the item vectors of the multiple items registered in the item database at regular intervals.

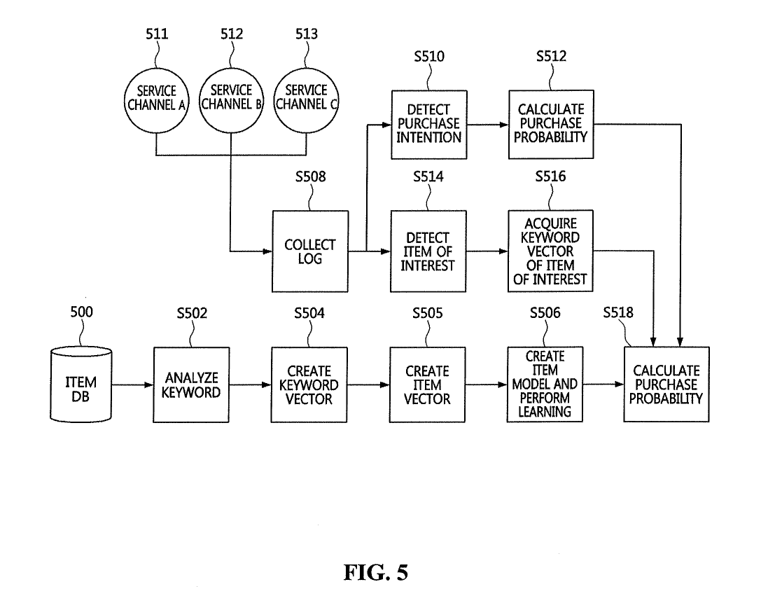

FIG. 5 is a view that shows an example of a user intention profiling process according to the present invention.

Referring to FIG. 5, in the user intention profiling process according to the present invention, first, keywords may be analyzed at step S502 based on item information about multiple items stored in an item database 500.

Here, keyword sets for respective multiple items may be created by analyzing keywords based on morphemes.

Then, keyword vectors may be created at step S504 based on the keyword sets, each of which is created for each of the multiple items through keyword analysis.

Here, multiple context keywords are extracted in consideration of the context of each of the multiple keywords included in each keyword set, the relationship of the multiple context keywords to the multiple keywords is represented as vector values, and learning is performed such that the mean log probability reaches the maximum based on the vector values, whereby multiple keyword vectors may be created.

Then, item vectors are created for the respective multiple items based on the keyword vectors at step S505, and item models may be created at step S506 by performing learning based on the item vectors.

Here, a weight for each keyword is applied to the multiple keyword vectors, and the sum of scalar products of the multiple keyword vectors, to which the weight for each keyword is applied, is calculated, whereby an item vector may be created.

Then, when logs about the online behavior of a user are collected based on service channels 511, 512 and 513 at step S508, the purchase intention of the user and an item of interest may be detected at steps S510 and S514 using behavior data created based on the logs.

Here, a purchase probability may be calculated at step S512 based on the purchase intention of the user, and the keyword vector of the item of interest may be acquired at step S516.

Here, a purchase probability model may be created by extracting a purchase pattern and a non-purchase pattern based on the behavior pattern related to successive behavior that is frequently observed when multiple users who use a corresponding online site make a purchase and based on the behavior pattern related to successive behavior that is frequently observed when the multiple users do not make a purchase.

Then, keyword ranking information related to the user is created based on the similarity between the keyword vector of the item of interest and each of the item models, and a user intention profile may be created at step S518 in consideration of the keyword ranking information, the item of interest, the purchase probability, and the like.

Here, the user intention profile may include information about a cluster of items that the user is interested in, which is created by applying the purchase probability of the behavior pattern, corresponding to successive behavior, to the item vector of the item of interest as a weight.

That is, the user intention profile may include a profile of the user's item of interest and a profile of the user's keyword of interest.

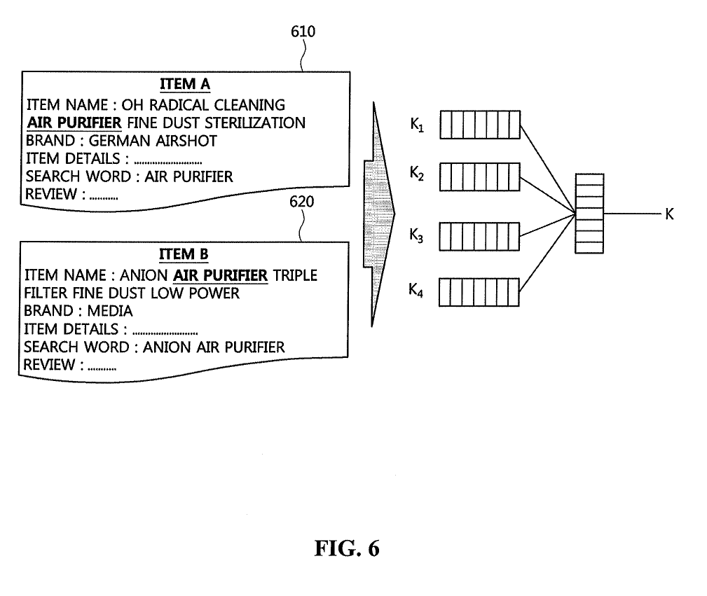

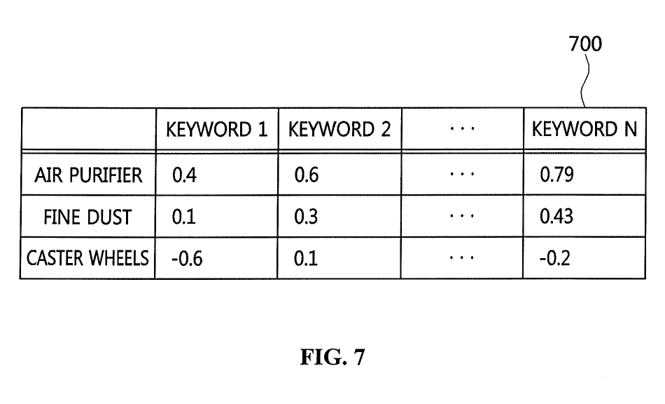

FIG. 6 and FIG. 7 are views that show an example of creation of a keyword vector based on word embedding according to the present invention.

Referring to FIG. 6 and FIG. 7, in order to create keyword vectors according to the present invention, multiple context keywords for multiple keywords may be extracted first, as shown in FIG. 6.

For example, as context keywords, “OH radical”, “air purifier”, “fine dust”, “sterilization”, and the like may be extracted from item A, which has “air purifier” as the keyword thereof, as shown in FIG. 6. Similarly, as context keywords, “anion”, “air purifier”, “triple filter”, “low power”, “fine dust”, and the like may be extracted from item B, which has “air purifier” as the keyword thereof.

Here, as shown in FIG. 7, the keyword “air purifier” may be represented as a keyword vector 700, from which the meaning of an air purifier is drawn, by numerically learning the context keywords, extracted from the item A and the item B, in the vector space.

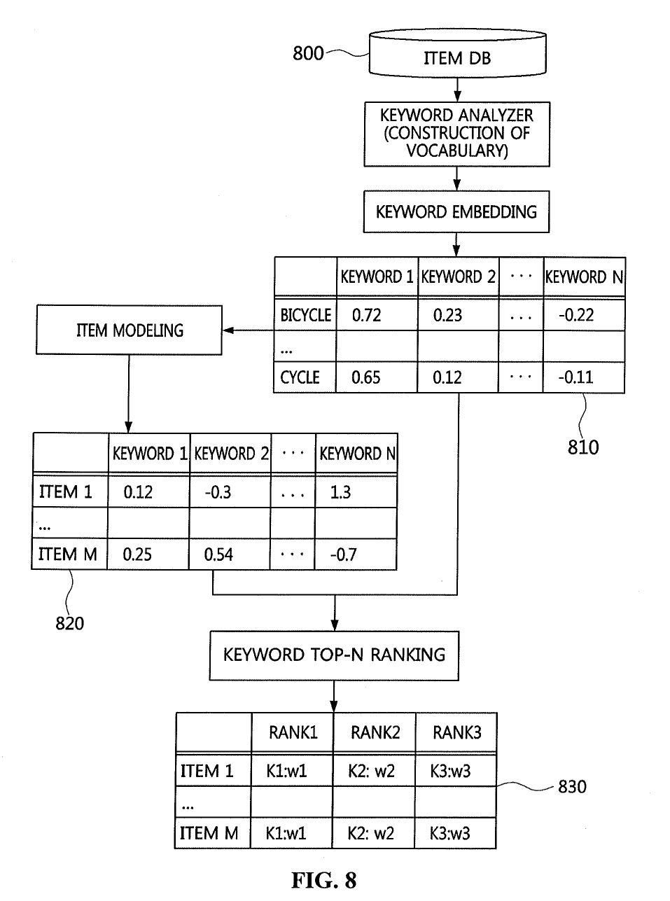

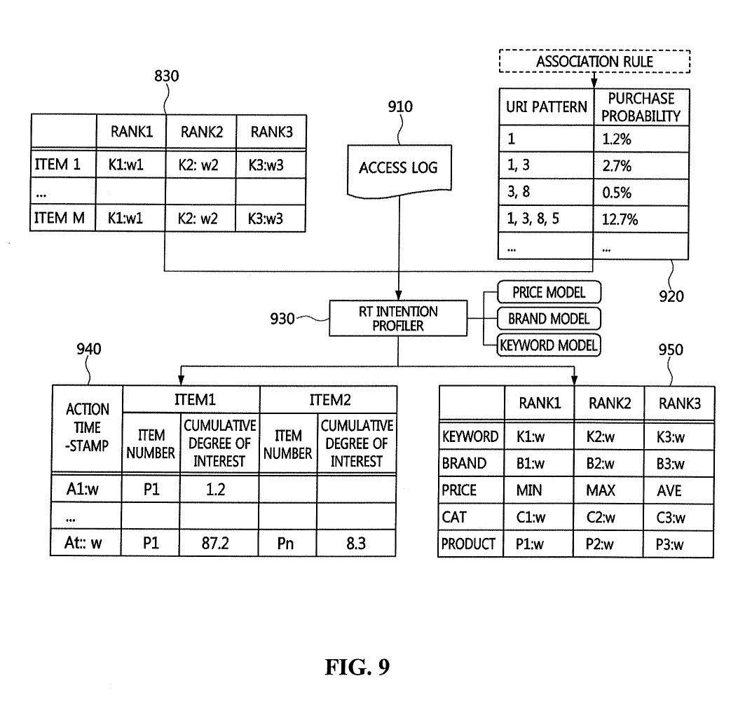

FIG. 8 and FIG. 9 are views that show the process of creating a user intention profile according to the present invention.

Referring to FIG. 8 and FIG. 9, in order to create a user intention profile according to the present invention, an item model may be created first through the process illustrated in FIG. 8.

For example, the process of creating an item model is as follows.

First, item information about multiple items registered in an online site may be acquired from the item database illustrated in FIG. 8. Then, keywords are analyzed using a keyword analyzer, whereby keyword sets for the respective multiple items may be created.

Then, keyword vectors 810 illustrated in FIG. 8 may be created for the respective keywords by performing context-based word embedding based on the multiple keywords included in the keyword set. That is, multiple context keywords are extracted in consideration of the context of each of the multiple keywords, the relationship of the multiple context keywords to the multiple keywords is represented as vector values, and learning is performed such that the mean log probability reaches the maximum based on the vector values, whereby multiple keyword vectors may be created.

Then, a weight for each keyword is applied to the multiple keyword vectors, and the sum of scalar products of the multiple keyword vectors, to which the weight for each keyword is applied, is calculated, whereby item vectors 820 illustrated in FIG. 8 may be created.

Then, the similarity between the keyword vector and the item vector is calculated, and a keyword having a high similarity is ranked Top K, whereby an item model 830 may be created as shown in FIG. 8.

Then, a user intention profile may be created using the item model 830, as shown in FIG. 9.

For example, the process of creating a user intention profile is as follows.

First, using a user intention profiler 930 according to an embodiment of the present invention, a purchase probability based on the purchase intention of a user may be calculated based on the log 910, collected with regard to the online behavior of the user.

Here, the purchase probability may be calculated depending on the extracted behavior pattern corresponding to the URI pattern in the behavior data created based on the log.

Then, the item in which the user is interested is detected based on each of the URI patterns, that is, the behavior pattern, and information about the item of interest is profiled based on the brand, the price, the keyword, and the like of the item of interest, whereby a profile 940 of the item of interest, illustrated in FIG. 9, may be created.

Here, the profile 940 of the item of interest may include the degree of interest in each item of interest.

Also, using the user intention profiler 930 according to an embodiment of the present invention, keyword ranking information 950 related to the user may be created based on the item model 830 and the keyword vector of the item of interest.

Here, the degree of interest in each keyword may be calculated by multiplying the purchase probability of the item of interest by the similarity between the item model 830 and the keyword vector of the item of interest. Then, the degree of interest is sorted, whereby keyword ranking information 950 may be created.

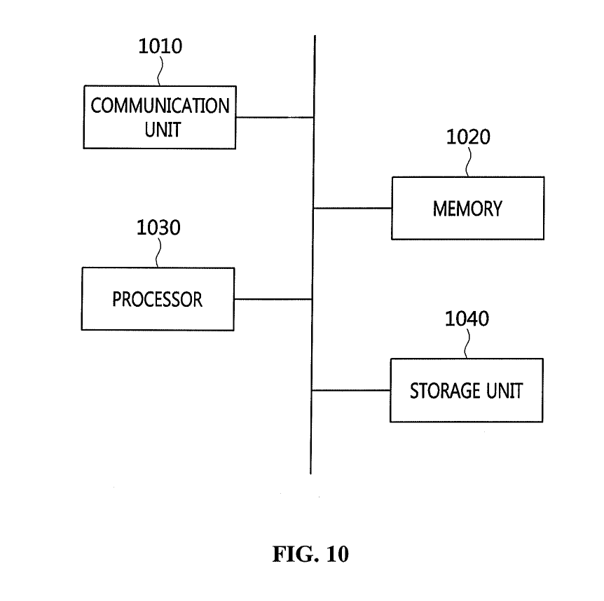

FIG. 10 is a block diagram that shows a server for performing user intention profiling according to an embodiment of the present invention.

Referring to FIG. 10, the server for performing user intention profiling according to an embodiment of the present invention includes a communication unit 1010, memory 1020, a processor 1030, and a storage unit 1040.

The communication unit 1010 functions to send and receive information that is necessary for user intention profiling using a communication network. Particularly, the communication unit 1010 according to the present invention may receive data about the online behavior of a user and item information about multiple items registered in an online site from a separate operating server for running the online site.

The memory 1020 stores a log that is collected in real time with regard to the online behavior of the user who accesses the online site and item models created based on the multiple items registered in the online site.

The processor 1030 creates behavior data corresponding to successive behavior based on the logs that are collected in real time with regard to the online behavior of the user who accesses the online site.

The present invention is for performing user intention profiling for a user who accesses an online site. To this end, the present invention may analyze the successive behavior of a user as well as behavior pertaining to a certain item or category. That is, successive online behavior from a user's visit to an online site to the purchase of an item may be analyzed.

Here, the purchase intention of the user and information about the item of interest observed in successive behavior to search for an item are profiled using a brand, a desired price level, a keyword representing the feature of an item, and the like. Here, unlike the conventional method, in which only an item name or a detailed description of the item is used to detect the intention to search for the item of interest, meaningful keywords extracted through language processing and statistical analysis performed on an item name, a brand name, detailed information about a product, reviews, Q&A, a search keyword, and the like may be used to create a user intention profile for the user.

Here, a log may pertain to the online behavior of a user who is accessing the online site. For example, a log may represent explicit behavior, such as clicking on an item, checking a review, adding to a cart or deleting from a cart, making a payment, inputting a search word, clicking on an advertisement, social media activities, such as liking or sharing, or the like. Also, a log may include any implicit behavior from which the item of interest may be inferred, for example, behavior related to User Experience (UX), such as scrolling a mouse wheel, swiping out the screen, or the like, remaining for a long time on a certain page, revisiting the page of the same or a similar item or category, or the like. Here, the online behavior is not limited to these examples.

Here, a search word including the intention of the user, a price, optional information, and the like may be extracted based on URI information included in the log, and the extracted information is classified for each user, whereby behavioral data in a standardized format may be created.

Here, the log may be collected in real time immediately in response to the behavior of a user from the time at which the user accesses the online site. Also, the log may be collected in the form of a data stream, and may be preprocessed in order to be processed into a data format that is suitable for use in creating a user intention profile.

Here, the user intention profiling method according to an embodiment of the present invention may use the real-time online behavior of a user, as described above. That is, unlike the conventional method in which an item expected to be bought by a user or a purchase probability is determined using a record on past purchases of the user or profile information, the present invention may infer an item that is highly likely to be bought in the near future or a category including such an item based on a behavior pattern, such as the page that a user is visiting in the e-commerce site that the user is accessing. Because user intention profiling for the user who is accessing the online site is performed using this method, a user intention may be detected more accurately than when the conventional method is used.

Here, the channel used to collect a log is not limited to a specific channel. For example, a log corresponding to the online behavior of the user may be collected in real time through any of various channels, such as a mobile web, a mobile application, and a desktop web.

Also, the server according to an embodiment of the present invention may receive a log that is unified by aggregating all logs or a log that is simplified by aggregating logs generated in some terminals. That is, the method of collecting logs is not limited to any specific method.

Here, the behavior data may include at least one of the time at which behavior takes place, a user id, a terminal id, a URI, a search word, and information related to an item. Here, the information related to an item may include an item number or a category number for identifying the corresponding item. Also, the information related to an item may include metadata based on which the importance of online behavior may be determined, such as the price of the item, an option related thereto, or the like.

Here, behavior data may be created for each session based on the time at which a user accesses the online site.

For example, the period from the time at which a user logs on to the online site to the time at which the user logs off therefrom is set as a single session, logs for online behavior observed during the single session are collected, and behavior data may be created therefrom.

In another example, the period from the time at which a user accesses an online site to the time at which the user leaves the online site is set as a single session, and behavior data for the session may be created.

Here, the start and termination of a single session may be set differently, and are not limited to a specific time.

Also, the processor 1030 detects the purchase intention of the user and the item of interest based on the behavior data.

Here, the purchase intention may include a purchase probability related to the user.

Here, the purchase probability may increase when the successive online behavior of the user is determined to be meaningful.

Also, the purchase probability may also be calculated by comparing a behavior pattern with a purchase probability model, which is created for the online site.

Here, the purchase probability model may be a purchase probability model for the online site. That is, a behavior pattern is extracted from the behavior data collected from the corresponding online site, the frequency with which a purchase is made or not made in the extracted behavior pattern is analyzed, and a purchase probability model may be created based on the analysis result.

For example, a purchase probability model may be created by extracting a purchase pattern and a non-purchase pattern based on the behavior pattern related to successive behavior that is frequently observed when multiple users who use the corresponding online site make a purchase and based on the behavior pattern related to successive behavior that is frequently observed when the multiple users do not make a purchase. Here, when the number of times a purchase is made or a purchase is not made is less than a certain number, the behavior pattern is not considered, whereby the operation for creating a purchase probability model may be processed faster.

Accordingly, the behavior pattern extracted from the behavior data created so as to correspond to the user is compared with the purchase pattern or non-purchase pattern included in the purchase probability model, whereby whether or not the user will buy an item may be calculated as a probability.

Also, the processor 1030 extracts keyword ranking information related to the user in consideration of the similarity between a keyword vector of the item of interest and each of item models created based on multiple items registered in the online site.

Here, a keyword vector corresponding to the item of interest may be acquired based on multiple keyword vectors that have been created in advance for the multiple items.

For example, the server according to an embodiment of the present invention may create multiple keyword vectors by acquiring item information about multiple items registered in the online site and then store the multiple keyword vectors in a separate database. When the item in which the user is interested is detected, the corresponding item, among the multiple items, is retrieved, whereby the keyword vector of the corresponding item may be acquired.

The process of creating multiple keyword vectors will be briefly described below.

First, keyword sets for the respective multiple items may be created by analyzing keywords based on morphemes.

For example, morphemes may be analyzed by acquiring item information from the item database that stores item information about multiple items registered in the online site. Then, based on complex keyword processing and named entity recognition of the result of analysis of morphemes, keywords that represent the item well may be extracted.

Here, the keywords may be extracted based on various information corresponding to the unique brand name of an item, the model name thereof, the size thereof, the color thereof, the intended use thereof, the purpose thereof, and the like.

Here, if there is a pair of keywords, the PMI of which has a preset PMI value, among the multiple keywords, the keywords in the pair are combined into a complex keyword so as to be regarded as a single keyword.

For example, it may be assumed that keyword B, which is the brand name of item A, is extracted from the result of analysis of morphemes in item information about the item A. Then, when keyword C, which is statistically meaningful with regard to the keyword B, is extracted using word co-occurrence, a complex keyword that combines the keyword B with the keyword C may be regarded as a single keyword about item A.

Here, meaningful complex keywords, each of which is configured with two or more words, may be extracted and included in each keyword set by repeatedly performing complex keyword processing for the result of analysis of morphemes in item information of all of the multiple items.

Then, multiple keyword vectors may be created for the respective keywords included in each of the keyword sets.

Here, the keyword vector may be a semantic vector of a certain size, represented by applying a context-based word-embedding model to a specific keyword. That is, the semantic vector is a vector of a specific size that is learned from multiple keywords used for representing the characteristics of an item and the context of the keywords, and may be a numeric expression of the characteristic of the item represented with the keyword in a vector space.

Here, multiple context keywords are extracted in consideration of the context of each of the multiple keywords, and the relationship of the multiple context keywords to the multiple keywords may be represented as vector values.

For example, it may be assumed that “OH radical”, “air purifier”, “fine dust”, “sterilization”, and the like are extracted as the context keywords of item A, the keyword of which is “air purifier”. Similarly, it may be assumed that “anion”, “air purifier”, “triple filter”, “low power”, “fine dust”, and the like are extracted as the context keywords of item B, the keyword of which is “air purifier”. Here, the keyword “air purifier” may be represented as a specific vector value, from which the meaning of an air purifier is drawn, by numerically learning the context keywords extracted from the item A and the item B in a vector space.

Here, learning is performed such that the mean log probability reaches the maximum based on the vector values, whereby multiple keyword vectors may be created.

For example, a keyword vector for keyword K may be the result of learning that is performed such that the mean log probability of the keyword K for all of the context keywords thereof is maximized, and may be calculated using the following Equation (1):

$$\frac{1}{T} {\sum }_{t = k}^{T - k} log Pr ( {K}_{t} \vert {K}_{t - k} , … , {K}_{t + k} ) \qquad ( 1 )$$

Here, item models may be learned based on item vectors that are created so as to correspond to the multiple items.

Here, the item vector may be the unique feature vector of an item that is represented using the keyword set corresponding to the item and the keyword vectors created based on the multiple keywords included in the keyword set.

Here, a weight for each keyword is applied to the multiple keyword vectors, and the sum of scalar products of the multiple keyword vectors, to which the weight for each keyword is applied, is calculated, whereby an item vector may be created.

For example, the item vector Pᵢ may be calculated as the sum of scalar products of the weight λᵢⱼ for the item, assigned to each of m keywords extracted from item information, and the keyword vector Kᵢⱼ, as shown in Equation (2).

$${P}_{i} = {\sum }_{i = 1}^{m} {λ}_{ij} {K}_{ij} \qquad ( 2 )$$

Here, the dimension of the item vector may be the same as that of the keyword vector.

Here, the weight for each keyword may be calculated in consideration of at least one of the frequency of the keyword in item information, the proportion of items in which the keyword appears, and the location at which the keyword appears.

For example, when the frequency of the keyword in item information is tf, when the proportion of items in which the keyword appears is idf, when the weight depending on the location at which the keyword appears is α, and when the number of multiple items registered in the item database is |P|, the weight λᵢⱼ for each keyword may be calculated as shown in Equation (3).

$${λ}_{ij} = \frac{α \times {tf}_{ij}}{{\sum }_{k = 1}^{k = m} {tf}_{ik}} \times {idf}_{ij} , {idf}_{ij} = \frac{\vert P \vert}{count ( {P}_{j} )} \qquad ( 3 )$$

where Pⱼ denotes the number of items that include the j-th keyword, among multiple items.

Here, depending on the quality of the item vector, the weight model of Equation (3) may be adjusted.

Here, the item models may be learned for the item vectors of the multiple items registered in the item database at regular intervals.

Here, the size of the item vector may be the same as the size of the keyword vector. When user intention profiling is performed in real time, the size of the keyword vector and item vector may be set in consideration of available memory and the efficiency of parallel distributed processing.

Also, the processor 1030 creates a user intention profile for the user based on at least one of the item of interest, keyword ranking information, and the purchase probability included in the purchase intention.

Here, the user intention profile may include information about a cluster of items that the user is interested in, which is created by applying the purchase probability of the behavior pattern, corresponding to successive behavior, to the item vector of the item of interest as a weight.

That is, the user intention profile may include a profile of the user's item of interest and a profile of the user's keyword of interest.

Here, a profile of a price range desired by the user and the preferred brand may also be calculated by applying the purchase probability of the behavior pattern as a weight.

For example, a price range may be readjusted through linear interpolation between the current desired price range, which is detected based on the behavior data, and the price range value that is initialized based on at least one of the minimum price, the average price, and the maximum price.

In another example, the purchase probability of the behavior pattern, from which each of the items in which the user is interested is detected, is applied to the price information of the corresponding item as a weight, whereby the price range may be estimated.

Also, in the case of the preferred brand, the purchase probability of the behavior pattern, from which the item of interest is detected, is applied to the brand of the corresponding item as a weight, whereby the degree of interest in the brand may be calculated.

That is, the server according to an embodiment of the present invention calculates the similarity between the item model and the vector value, acquired by applying the purchase probability to the item vector for the item of interest as a weight, and includes a keyword having a high similarity in the user intention profile depending on the ranking thereof, thereby providing information about keywords in which the user is interested.

Alternatively, the server according to an embodiment of the present invention extracts N keywords for each of the multiple items registered in the online site, and applies the probability of buying an item to the keywords extracted for the corresponding item as a weight, thereby creating keyword ranking information for each item. Then, the degree of interest in each of the keywords is calculated by multiplying the probability of buying the item of interest, which is extracted based on the behavior data of the user, by the similarity of the keywords of the item of interest, and the calculated degree of interest is sorted, whereby keyword ranking information may be created.

Here, the degree of interest in the item, that is, the purchase intention of the user, may decrease over time. Also, when the item of interest has been bought, interest in the corresponding item may be determined to be lost.

Accordingly, while user intention profiling is being performed in real time, the item for which a search activity related to purchase is not conducted during a certain session is subject to application of an exponential decay function with a time constant, whereby the purchase probability, which is a weight to be applied to the item vector, may be gradually decreased.

Also, when a specific item has been bought, user intention profiling may be performed after setting the purchase probability that is finally applied to the item to zero.

As described above, user intention profiling serves to structuralize and represent information about the features of the item that a user is searching for in the online site, and the key feature information may be shown in the category of the item, the brand thereof, the price thereof, the model name thereof, keywords related to the main attributes and functions of the item, and keywords that represent additional information about the item. Here, the category, the brand, and the price may use a predefined keyword or code, and the main attributes or functions of the item may be represented in different types even if they have the same meaning.

Also, the present invention represents the item characteristic preferred by the user, observed in the item search intention, as a keyword. Here, rather than using the word used to describe the item information, that is, rather than using the keyword itself, consecutive words that are used therewith may be extracted and used as a single complex keyword based on statistical word co-occurrence. Also, various context keywords that appear around the extracted keyword are encoded into a vector space of a fixed dimension, and user intention profiling may be performed using the result of encoding.

Also, a keyword vector created according to an embodiment of the present invention may efficiently represent the item search intention of the user because it comprehensively reflects the semantic characteristics of the keyword related to the item and because it is good at combining keywords that have similar meaning but are represented in different types.

Particularly, in the conventional method for normalizing keywords using ontology, there may be issues, such as overhead arising from the construction of ontology, the degree of expressiveness depending on the scale of ontology, and the like. However, when keyword embedding according to the present invention is used, because clustering of keywords having similar meaning, selection of representative keywords, and the like may be automatically performed, cost efficiencies may be expected. Also, because measurement of the degree of similarity and keyword ranking are performed through vector operations, a parallel and distributed processing environment may be effectively used when real-time service is provided for a large number of items and users.

Also, because an item model and the item search intention of a user are represented using a keyword-embedding vector as a medium therebetween, extracting a keyword for representing the feature of an item, ranking keywords in which the user is interested, and the like may be performed using vector operations, and a similar item, a similar user, the relationship between an item and a user, an item or user that is associated with the feature represented by a certain keyword, and the like may be effectively retrieved using the vector similarity operation.

The storage unit 1040 may support functions for user intention profiling according to an embodiment of the present invention as described above. Here, the storage unit 1040 may operate as separate mass storage, and may include control functions for performing operations.

Meanwhile, the server may store information in memory installed therein. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard disk device, an optical disk device, or any other kind of mass storage.

Using the above-described server, the intention of the user who uses e-commerce may be analyzed in real time and the analysis result may be provided as data.

Also, the analysis of a behavior log generated when a user uses e-commerce service and item search intention of the user may be profiled using explicit keywords and figures so as to be used to enhance the effectiveness of personalized recommendation, advertisement, searching, and marketing.

Also, there may be provided a method for effectively processing the user's search intention related to purchase in real time when there is a large number of users and a large number of items.

Also, information about the features of the item or product that a user is searching for may be effectively structuralized and represented.

Also, clustering of keywords having similar meaning, selection of representative keywords, and the like are automatically performed, whereby cost efficiencies may be realized.

Also, a similar product, a similar user, the relationship between a product and a user, a product or user that is associated with the feature represented by a certain keyword, and the like may be effectively retrieved.

Also, real-time support for user profiling and the use of the result thereof in a parallel distributed environment may be improved.

The functional operations and implementations of the subject matter described herein may be implemented as digital electronic circuitry, or may be implemented in computer software, firmware, or hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium in order to control the operation of a processing system or to be executed by the processing system.

The computer-readable medium may be a machine-readable storage device, a machine-readable storage substrate, a memory device, a composition of material that affects a machine-readable radio-wave-type signal, or one or more combinations thereof.

As used herein, the terms ‘system’ or ‘device’ include all kinds of apparatuses, devices and machines for processing data, which include, for example, a programmable processor and a computer, or multiple processors and a computer. In addition to hardware, the processing system may also include, for example, code that configures processor firmware and code that configures an execution environment for computer programs in response to a request from a protocol stack, a database management system, an operating system, or one or more combinations thereof.

A computer program (also known as a program, software, a software application, a script or code) may be written in any form of programming language including a compiled or interpreted language, or an a priori or procedural language, and may be deployed in any form including standalone programs or modules, components, subroutines, or other units suitable for use in a computer environment. The computer program does not necessarily correspond to a file in a file system. The program may be stored in a single file provided to the requested program, in multiple interactive files (for example, files storing one or more modules, subprograms or portions of code), or in a part of a file containing other programs or data (for example, one or more scripts stored in a markup language document). The computer program may be located on a single site, or may be distributed across multiple sites such that it is deployed to run on multiple computers interconnected by a communications network or on a single computer.

The computer-readable medium suitable for storing computer program instructions and data may include, for example, semiconductor memory devices, such as EPROM, EEPROM and flash memory devices, all types of nonvolatile memory, including magnetic disks, such as internal hard disks or external disks, magnetic optical disks, CD-ROMs and DVD-ROMs, media, and memory devices. A processor and memory may be supplemented by special-purpose logic circuits, or may be integrated therewith.

Implementations of the subject matter described herein may be realized on an arithmetic system including, for example, a back-end component such as a data server, a middleware component such as an application server, a front-end component such as a client computer with a web browser or a graphical user interface through which a user may interact with the implementations of the subject matter described herein, or one or more combinations of the back-end component, the middleware component, and the front-end component. The components of the system may be interconnected using any form or medium of digital data communication such as a communication network.

While the present invention includes a number of specific implementation details, they should not be construed as limiting the scope of the invention or the claimable scope, but should be understood as a description of features that may be specific to particular embodiments of the invention. Similarly, the specific features described herein in the context of individual embodiments may be implemented by being combined in a single embodiment. Alternatively, various features described in the context of a single embodiment may also be implemented in multiple embodiments individually or in any suitable sub-combination. Further, although such features may be described as operating in a particular combination and initially claimed as such, one or more features from the claimed combination may be excluded from the combination in some cases, or the claimed combination may be altered to a sub-combination or variation thereof.

Also, while this specification illustrates operations in the drawings in a particular order, it should not be understood that such operations must be performed in the particular order or the sequential order shown in the drawings in order to obtain the desired result, or that all of the illustrated operations should be performed. In certain cases, multitasking and parallel processing may be advantageous. Also, separation of the various system components of the above-described embodiment should not be understood as requiring such separation in all embodiments, and it should be understood that the program components and systems described above may generally be integrated into a single software product or packaged into multiple software products.

According to the present invention, behavior data corresponding to successive behavior is created based on logs that are collected in real time with regard to the online behavior of a user who accesses an online site, the purchase intention of the user and the item of interest are detected based on the behavior data, keyword ranking information related to the user is extracted in consideration of the similarity between a keyword vector of the item of interest and item models created based on multiple items registered in the online site, and a user intention profile corresponding to the user may be created based on at least one of the item of interest, the keyword ranking information, and the purchase probability included in the purchase intention. Also, according to the present invention, the search intention of customers is effectively processed in real time, whereby sellers or providers efficiently provide advertisements, promotions, vouchers, and the like personalized for individual customers, and the volume of transactions in e-commerce may be increased.

According to the present invention, the intention of a user who uses e-commerce may be analyzed in real time and provided as data.

Also, the present invention may analyze behavior logs generated when a user uses e-commerce service, and may profile a user's intention to search for an item using explicit keywords and figures so as to be used to improve the effectiveness of personalized recommendation, advertisement, searching, and marketing.

Also, the present invention may provide a method for effectively processing the user's search intention related to purchase in real time when there is a large number of users and a large number of items.

Also, the present invention may effectively structuralize and represent the feature information of the item or product that a user is searching for.

Also, the present invention may automatically perform clustering of keywords having similar meaning, selection of representative keywords, and the like, thereby realizing cost efficiencies.

Also, the present invention may effectively search for a similar product, a similar user, the relationship between a product and a user, a product or user that is associated with the feature represented by a certain keyword, and the like.

Also, the present invention may improve real-time support for user profiling and use of the result thereof in a parallel distributed environment.

This specification is not intended to limit the present invention to the specific terms disclosed herein. Therefore, although the present invention has been described in detail with reference to the above examples, those skilled in the art may conceive alternations, modifications, and variations on these examples without departing from the scope of the present invention. The scope of the present invention is defined by the appended claims rather than the description, and it should be construed that all alternations and modifications derived from the meaning and scope of the appended claims and their equivalents are included within the scope of the present invention.

What is claimed is:

1. A method for user intention profiling, comprising:
creating behavior data corresponding to successive behavior based on logs that are collected in real time with regard to online behavior of a user who accesses an online site;
detecting a purchase intention of the user and an item of interest based on the behavior data;
acquiring a keyword vector corresponding to the item of interest and extracting keyword ranking information related to the user in consideration of similarity between the keyword vector and item models created based on multiple items registered in the online site; and
creating a user intention profile for the user based on at least one of the item of interest, the keyword ranking information, and a purchase probability included in the purchase intention.

2. The method of claim 1, wherein the item models are learned based on item vectors created so as to correspond to the respective multiple items.

3. The method of claim 2, further comprising:
creating keyword sets for the respective multiple items by analyzing keywords based on morphemes;
creating multiple keyword vectors for multiple keywords included in each of the keyword sets; and
applying a weight for each keyword to the multiple keyword vectors and calculating a sum of scalar products of the multiple keyword vectors to which the weight for each keyword is applied, thereby creating the item vector.

4. The method of claim 3, wherein creating the multiple keyword vectors is configured to extract multiple context keywords in consideration of a context of each of the multiple keywords, to represent a relationship of the multiple context keywords to the multiple keywords as vector values, and to perform learning such that a mean log probability reaches a maximum based on the vector values, thereby creating the multiple keyword vectors.

5. The method of claim 3, wherein creating the keyword sets is configured such that, when there is a keyword pair that has a preset reference Pointwise Mutual Information (PMI) value, among the multiple keywords, keywords corresponding to the keyword pair are combined as a single complex keyword so as to be regarded as a single keyword.

6. The method of claim 3, further comprising:
calculating the weight for each keyword in consideration of at least one of a frequency of the keyword in item information, a proportion of items in which the keyword appears, and a location at which the keyword appears.

7. The method of claim 1, wherein the behavior data includes at least one of a time at which behavior takes place, a user id, a terminal id, a Uniform Resource Identifier (URI), a search word, and information related to an item.

8. The method of claim 2, wherein the user intention profile includes information about a cluster of items that the user is interested in, which is created by applying a purchase probability of a behavior pattern, corresponding to the successive behavior, to the item vector corresponding to the item of interest as a weight.

9. The method of claim 8, further comprising:
calculating the purchase probability by comparing the behavior pattern with a purchase probability model created for the online site.

10. A server, comprising:
memory for storing logs collected in real time with regard to online behavior of a user who accesses an online site and item models created based on multiple items registered in the online site; and
a processor for detecting a purchase intention of the user and an item of interest using behavior data created so as to correspond to successive behavior based on the logs, extracting keyword ranking information related to the user in consideration of similarity between a keyword vector corresponding to the item of interest and the item models, and creating a user intention profile corresponding to the user based on at least one of the item of interest, the keyword ranking information, and a purchase probability included in the purchase intention.
